(19) United States
(12) Patent Application Publication
(10) Pub. No.: US 2008/0032776 A1
(43) Pub. Date: Feb. 7, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/783,084

(22) Filed: Apr. 5, 2007

Related U.S. Application Data
(60) Provisional application No. 60/835,869, filed on Aug. 7, 2006.

(51) Int. Cl. A63F 13/00

(52) U.S. Cl. 463/20; 463/25

(57) ABSTRACT

A slot machine according to the present invention is a slot machine comprising: a display having a display area to which a plurality of symbols and a target specifying any of the symbols are to be arranged; and a controller, the controller rearranging the plurality of symbols within the display area and arranging the target within the display area, when a predetermined target arrangement condition is satisfied, and conducting a payout based on a symbol rearranged within the display area, the payout set to such a value that a payout based on the rearranged symbols specified by the target has a higher payout valued than a payout in an event that the rearranged symbol is not specified by the target.

### CROSS-REFERENCE TO RELATED APPLICATIONS

This application claims priority of U.S. Provisional Application No. 60/835,869 filed on Aug. 7, 2006. The contents of this application are incorporated herein by reference in their entirety.

### BACKGROUND OF THE INVENTION

1. Field of the Invention

The present invention relates to a slot machine and a playing method thereof.

2. Discussion of the Background

In conventional slot machines, if a player inserts game media such as medals, coins or bills into an insertion slot of the slot machine and pushes a spin button, then a plurality of symbols are displayed in a scrolling manner to a display provided on the front surface of a casing and, thereafter, the respective symbols are automatically stopped, as disclosed in U.S. Pat. Nos. 6,960,133 and 6,012,983, and 6,093,102. In this case, when the respective symbols start to be displayed in a scrolling manner by the input through the spin button, symbols are selected using random numbers, and if the combination of the selected symbols is a predetermined winning combination, this causes transition from a basic game to a bonus game (for example, a mystery bonus, a second game and the like) and, then, the bonus game is executed. Further, such slot machines are configured to conduct a payout depending on the winning state occurring along with progression of games.

Further, among conventional slot machines, there are some slot machines which conduct two types of payouts which are payouts determined according to the combinations of symbols rearranged along winning lines and payouts determined according to the number of displayed scatter symbols, as disclosed in U.S. Pat. No. 6,604,999 and US 2002-0065124-A1. In such conventional slot machines, payouts have nothing to do with positions of the winning lines where winning combinations are generated or positions of the displayed scatter symbols, and therefore there are requests for advent of a slot machine having new entertainment characteristics.

The contents of U.S. Pat. Nos. 6,960,133, 6,012,983, 6,093,102, and 6,604,999 and US 2002-0065124-A1 are incorporated herein by reference in their entirety.

### SUMMARY OF THE INVENTION

The present invention provides a slot machine having the following configuration.

That is, the slot machine of the present invention is a slot machine comprising: a display having a display area to which a plurality of symbols and a target specifying any of the symbols are to be arranged; and a controller. Here, the controller rearranges the plurality of symbols within the display area and arranges the target within the display area, when a predetermined target arrangement condition is satisfied, and conducts a payout based on a symbol rearranged within the display area, the payout set to such a value that a payout based on the rearranged symbol specified by the target has a higher payout value than a payout in an event that the rearranged symbol is not specified by the target.

Further, the present invention is allowed to adopt the following configuration in addition to the configuration mentioned above.

That is, in the slot machine of the present invention, the controller further comprises changing the size of the target in such a manner that the number of symbols which are to be specified by the target increases in accordance with increase in the number of BETs.

Further, the present invention is allowed to adopt the following configuration in addition to the configuration mentioned above.

That is, in the slot machine of the present invention, the controller further comprises increasing the payout based on the rearranged symbol specified by the target in accordance with the increase in the number of BETs.

### BRIEF DESCRIPTION OF THE DRAWINGS

FIG. 1 is a view for illustrating a symbol matrix;

FIG. 2 is a view illustrating a correspondence between symbols and payout values;

FIG. 3 is a view illustrating correspondence between numbers of BETs and sizes of a target;

FIG. 4A is a view illustrating an exemplary symbol matrix;

FIG. 4B is a view illustrating an exemplary symbol matrix;

FIG. 5 is a perspective view schematically illustrating a slot machine according to an embodiment of the present invention;

FIG. 6 is a block diagram illustrating an internal structure of the slot machine illustrated in FIG. 5;

FIG. 7 is a flow chart illustrating a subroutine of slot game execution processing;

FIG. 8 is a flow chart illustrating a subroutine of game execution processing in a case of arranging a target;

FIG. 9 is a flow chart illustrating another exemplary subroutine of game execution processing in a case of arranging a target;

FIG. 10 is a perspective view schematically illustrating a slot machine according to another embodiment of the present invention; and

FIG. 11 is a perspective view schematically illustrating a slot machine according to still another embodiment of the present invention.

### DESCRIPTION OF THE EMBODIMENTS

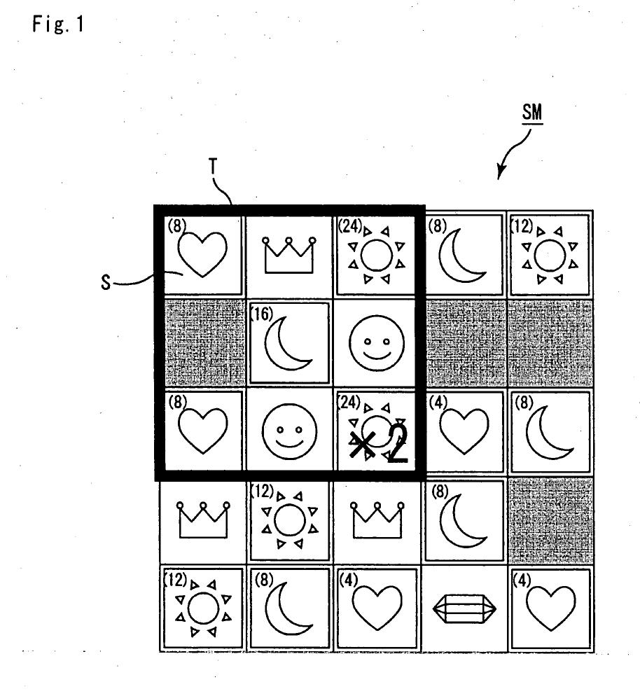

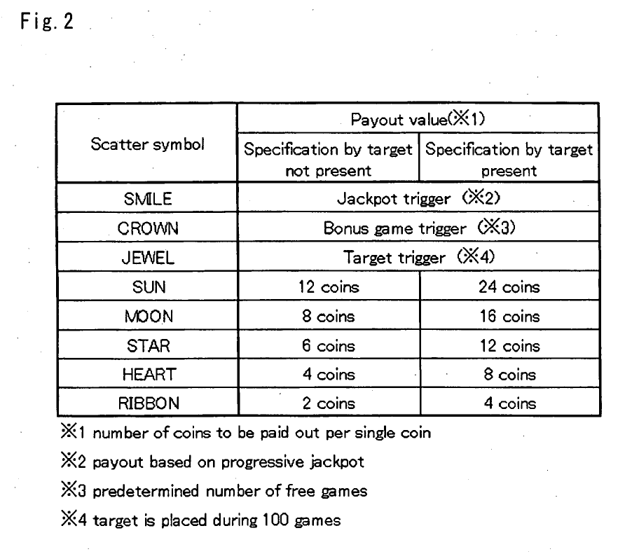

FIG. 1 is a view for illustrating a symbol matrix. FIG. 2 is a view illustrating a correspondence between symbols and payout values. A slot machine 10 is a standalone type slot machine that is not connected to a network, but the present invention can also be applied to a slot machine connected to a network.

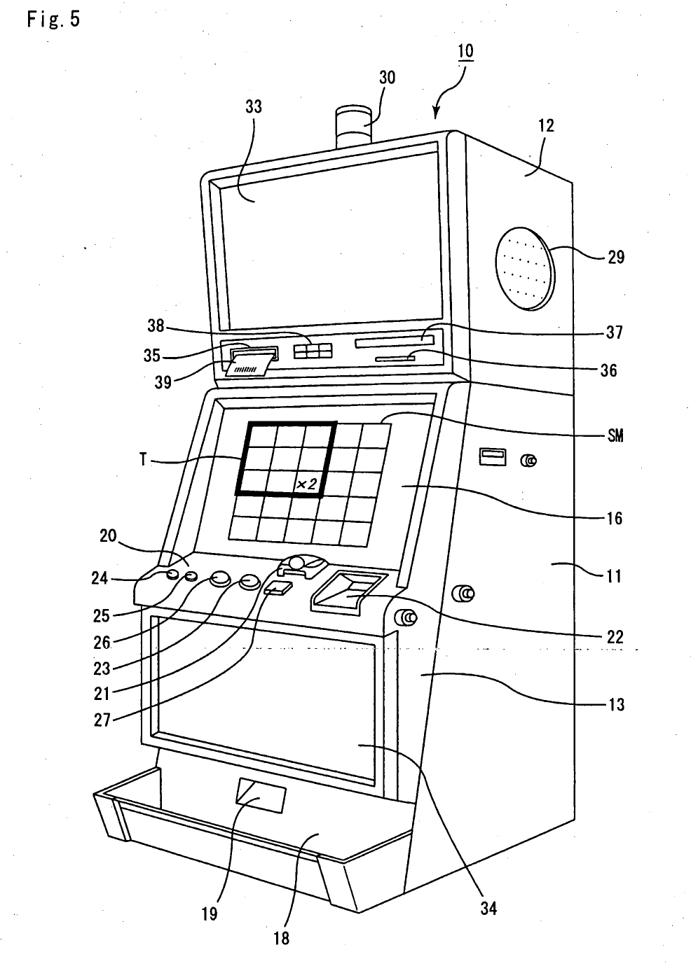

In FIG. 1, a symbol matrix SM which is displayed to a lower image display panel 16 (see FIG. 5) included in the slot machine 10 according to the present invention, is illustrated. The symbol matrix SM is constituted by a total of 25 symbols along 5 columns and 5 rows. Further, at an upper left portion of the symbol matrix SM, there is arranged a target T which specifies a total of 9 symbols along 3 columns and 3 rows. There is arranged, within the target T, an image of “×2” indicating that the payout value based on symbols arranged within the target T is twice the value offered when the symbols are arranged outside of the target T.

In the present embodiment, there are 9 types of symbols, “SMILE”, “CROWN”, “JEWEL”, “SUN”, “MOON”, “STAR”, “HEART”, “RIBBON” and “BLANK”.

The payout value is determined according to the symbols rearranged in the symbol matrix SM. More specifically, if more than five symbols of a same type are rearranged in the symbol matrix SM, a payout based on the symbols is conducted. In FIG. 1, the symbols enclosed in the double frames are symbols which enable the payout to be conducted, and the numerical characters illustrated upper and right of the respective symbols indicate the number of medals to be paid out based on the corresponding symbols.

As illustrated in FIG. 2, “SMILE” is a jackpot trigger. If five or more of “SMILE” are rearranged in the symbol matrix SM, a payout based on a progressive jackpot is conducted. Since the slot machine 10 is a standalone type slot machine, the payout based on the progressive jackpot is the sum of an accumulated value (a value resulted from accumulation of a portion of the number of inserted game media) in the single slot machine 10 and an initial payout value.

However, in the present invention, the accumulated value used in the event of a progressive jackpot is not limited thereto. For example, in the case where the slot machine is connected to a network, the accumulated value may be an accumulated value in the same type of slot machines in a single casino, an accumulated value in the same type of slot machines in the same area (for example, state or country), or the like.

In the present embodiment, the payout based on a progressive jackpot is conducted in preference to the payout based on other symbols or in preference to bonus games. Accordingly, if both a jackpot trigger and a bonus game trigger are generated at the same time, the payout based on the progressive jackpot is conducted, while no bonus game is executed.

Further, “CROWN” is a bonus game trigger. If five or more of “CROWN” are rearranged within the symbol matrix SM, then a free game is executed for a predetermined number of times (for example, for ten times). The free games are executed as if the same number of coins as that at the time of generation of the free games have been inserted, even though no coin has been inserted.

“JEWEL” is a target trigger. If five or more of “JEWEL” are rearranged within the symbol matrix SM, a target T (see FIG. 1) is arranged in the symbol matrix SM during a predetermined number of games (for example, 100 games). Namely, in the present embodiment, the target arrangement condition is that five or more target triggers (predetermined symbols) are rearranged within the symbol matrix SM. In the present embodiment, the condition required for ending the arrangement of the target T (hereinafter, also referred to as an ending condition) is that 100 games have been played since the start of the arrangement of the target T.

For the respective symbols “SUN”, “MOON”, “STAR”, “HEART” and “RIBBON”, the number of coin-out per single inserted coin is defined. The number of coin-out for the respective symbols is defined for the following two cases; a case (i) where there is the specification by a target and a case (ii) where there is no specification by a target. The number of coin-out defined for the aforementioned case (i) is set to twice the number of coin-out defined for the aforementioned case (ii). Further, the number of coin-out is not defined for “BLANK”.

In the slot machine 10, the number of BETs for a single game is set to within the range of 1 to 50 coins and, depending on the number of BETs, the size of the target T is changed.

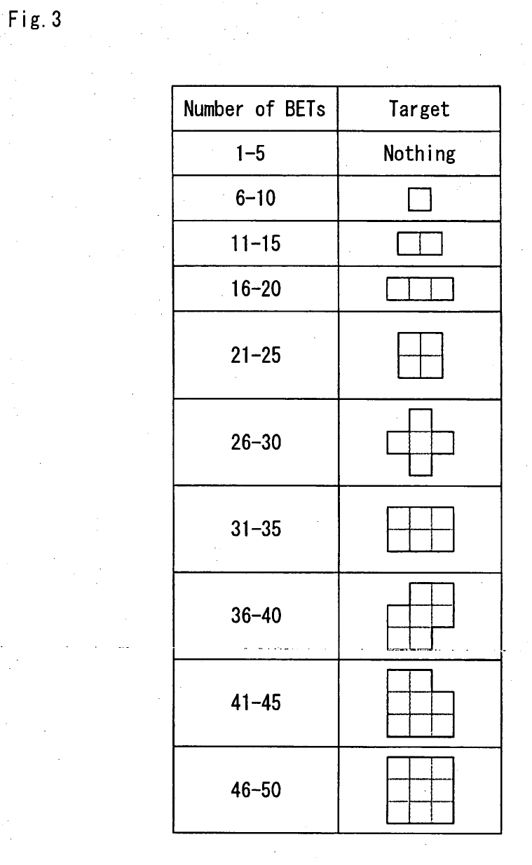

FIG. 3 is a view illustrating correspondence between numbers of BETs and sizes of a target T.

As illustrated in FIG. 3, in the slot machine 10, the size of the target T is changed in such a manner that the number of symbols S to be specified by the target T is increased with increasing number of BETs.

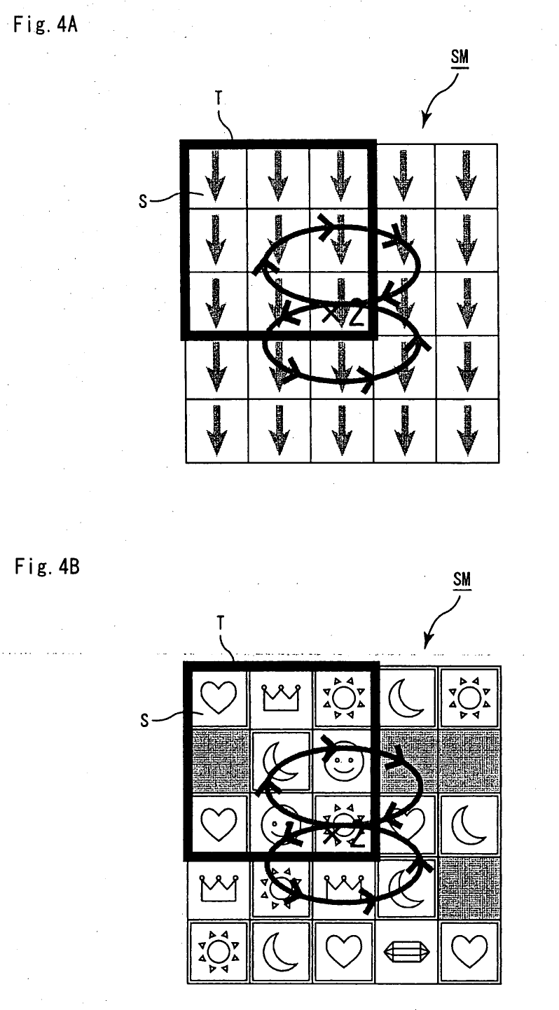

If 50 coins are betted and a game is started after the target arrangement condition is satisfied, scrolling of symbols S is started at all the positions included in the symbol matrix SM as illustrated in FIG. 4A. In the figure, downward arrows illustrated at the positions where respective symbols are arranged indicate symbols being scrolled. Further, in the symbol matrix SM, a target T capable of specifying a total of 9 symbols along 3 columns and 3 rows at a maximum is arranged in such a manner that it is moved in the direction of arrows having a figure of eight illustrated in the figure. As described above, the slot machine 10 performs scrolling display of symbols and movement of a target, concurrently. Thereafter, the slot machine 10 rearranges symbols, stops the target and conducts a payment in such a manner that the payment based on the rearranged symbols specified by the target has a higher payout value than the payout in an event that the rearranged symbols are not specified by the target, as illustrated in FIG. 2.

The present invention is not limited to the aforementioned embodiment and can employ the following configuration, for example.

If 50 coins are betted and a game is started after the target arrangement condition is satisfied, scrolling of all the symbols S included in the symbol matrix SM is started and, thereafter, symbols S are rearranged. In the event of establishment of a prize based on the rearranged symbols, as illustrated in FIG. 4B, a target T capable of specifying a total of 9 symbols along 3 columns and 3 rows at a maximum is placed in the symbol matrix SM, in such a manner that it is moved in the direction of arrows having a figure of eight illustrated in the figure. In this configuration, symbols are rearranged at first and, in the event that a prize is established as a result, a target is arranged.

While, in the examples illustrated in FIGS. 1 to 4, there have been described cases where the payouts based on the jackpot trigger and the bonus game trigger are not affected by the presence or absence of the specification by a target, the present invention is not limited to the case. For example, for the jackpot trigger, different initial set values can be defined for the aforementioned cases (i) and (ii). Also, for the bonus game trigger, different numbers of games can be defined for the aforementioned cases (i) and (ii).

While, in the examples illustrated in FIGS. 1 to 4, there have been described cases where the display area is a symbol matrix, it is not necessary that symbols are arranged in a matrix shape within the display area, in the present invention.

While, in the examples illustrated in FIGS. 1 to 4, there has been described a symbol matrix constituted by a total of symbols along 5 columns and 5 rows, there is no particular limitation on the number of symbols in the case where the display area is constituted by a symbol matrix. Also, the numbers of symbols along the columns and the rows of the symbol matrix can be made different from each other. The shapes, the types, the numbers and the like of symbols can be properly changed as required. While, in the examples illustrated in FIGS. 1 to 4, there have been described cases where symbols arranged within the display area are scatter symbols and the payout value is varied depending on whether or not a target specifies the scatter symbols. However, in the present invention, the payout value can be determined based on winning combinations established along winning lines.

In the examples illustrated in FIGS. 1 to 4, there have been described cases where the shape of the target is a rectangular shape which encloses symbols. However, there is no particular limitation on the shape of the target in the present invention. It is necessary only that the target is an image which specifies symbols and, for example, the target may be an image illustrating an arrow, a symbol background image exhibiting a color different from the color of the other symbol background image, and the like.

In the examples illustrated in FIGS. 1 to 4, there have been described cases where rearrangement of symbols and arrangement of a target are performed with the following timing; (I) scrolling display of symbols and movement of the target are concurrently performed and (II) rearrangement of symbols is performed and, in the event that a prize is established as a result, a target is arranged. However, there is no particular limitation on the timing of rearrangement of symbols and arrangement of a target and, for example, there may be a cases such as (iii) where a target is arranged at first, then scrolling of symbols is started and, thereafter, symbols are rearranged.

While, in the examples illustrated in FIGS. 1 to 4, there have been described cases where the size of the target is changed in such a manner that the number of symbols which is to be specified by the target is increased with increasing number of BETs, the present invention is not limited to the case, and the size of symbols can be changed to increase the number of symbols which is to be specified by a target. Namely, in the present invention, the changing the size of a target means changing the size of the target relative to symbols. Further, the present invention is not limited to the configuration which increases the number of symbols which is to be specified by a target with increasing number of BETs, and also can employ a configuration which increases the payout value based on symbols specified by a target with increasing number of BETs, a configuration which changes the shape of a target with increasing number of betted credits, and the like. Also, instead of employing only one of these configurations, a combination of plural configurations can be employed.

In the examples illustrated in FIGS. 1 to 4, there have been described cases where the target is moved within the display area (the symbol matrix SM). However, in the present invention, a target can be stationarily arranged to the display area. In the case where a target is moved within the display area, the size and the shape of the target can be changed along with the movement thereof.

In the examples illustrated in FIGS. 1 to 4, there have been described cases where the target arrangement condition is that a predetermined number (five) of or more scatter symbols (target triggers) are rearranged. However, in the present invention, the target arrangement condition is not limited to the case. For example, the target arrangement condition can be that a predetermined winning combination (for example, a combination of symbols of the same type) is established, a bonus game has ended, the cumulative number of games since the end of a bonus game has reached a predetermined number, and the like.

In the examples illustrated in FIGS. 1 to 4, there have been described cases where the ending condition is that a predetermined number of games (100 games) have been played since the start of the arrangement of a target. However, in the present invention, the ending condition is not limited to the case. For example, the ending condition can be that a predetermined number of or more scatter symbols are rearranged, a predetermined winning combination is established, a bonus game is started, and the like.

In the examples illustrated in FIGS. 1 to 4, there have been described cases where, in the event that a predetermined number of or more symbols of the same type are rearranged within the display area, a payout is conducted based on the rearranged symbols, regardless of whether or not there is specification by a target. However, the present invention is not limited to the case and, for example, a payout can be conducted based on rearranged symbols specified by a target, even if the number of the rearranged symbols specified by the target does not reach a predetermined number.

While, in the examples illustrated in FIGS. 1 to 4, there have been described cases where the number of coins to be paid out based on the rearranged symbols specified by the target is twice the number of coins to be paid out based on rearranged symbols which are not specified by the target, the present invention is not limited to the case. Also, for example, the number of coins to be paid out based on rearranged symbols specified by a target can be the same as the number of coins to be paid out when the rearranged symbols are not specified by the target and, also, a bonus game can be executed in the event that rearranged symbols are specified by the target, in such a manner that, if rearranged symbols are specified by the target, this allows free games, second games and the like to be played.

FIG. 5 is a perspective view schematically illustrating a slot machine according to an embodiment of the present invention.

The slot machine 10 includes: a cabinet 11; a top box 12 placed on the upper side of the cabinet 11; and a main door 13 provided at the front face of the cabinet 11. The lower image display panel 16 is provided in front of the main door 13. The lower image display panel 16 includes a liquid crystal display panel which displays a symbol matrix SM constituted by a total of 5×5=25 symbols. In the figure, there is illustrated a state where a target T constituted by a total of 3×3=9 symbols is displayed such that it is superimposed on the symbol matrix SM. The lower image display panel 16 corresponds to a display according to the present invention. In the lower image display panel 16, there are provided a number-of-credits display section 31 and a number-of-payouts display section 32 (not shown in the figure). The number-of-credits display section 31 displays an image indicating the number of credited coins. The number-of-payouts display section 32 displays an image indicating the number of coins to be paid out as the payout.

Further, a touch panel 69, which is not shown in the figure, is provided on the front face of the lower image display panel 16 and the player can input various kinds of commands by operating the touch panel 69.

Provided below the lower image display panel 16 are: a control panel 20 constituted by plural buttons 23 to 27 which are input by the player, commands associated with progress of the game; a coin receiving slot 21 accepting coins into the cabinet 11; and a bill validator 22.

The control panel 20 is provided with: a start button 23; a change button 24; a CASHOUT button 25; a 1-BET button 26; and a maximum BET button 27. The start button 23 is used for inputting a command to start the game. The change button 24 is used in a case where a player requests an attendant of a recreation facility to exchange money. The CASHOUT button 25 is used for inputting a command to pay out credited coins to a coin tray 18.

The 1-BET button 26 is used for inputting a command to bet one coin of the credited coins. The maximum BET button 27 is used for inputting a command to bet the maximum number of coins that can be bet on one game (50 coins in the present embodiment) of the credited coins.

The bill validator 22 is used not only for discriminating a false note from a true note but also for accepting the true note into the cabinet 11. The bill validator 22 may be configured such that a ticket 39 with a bar code which will be described later can be read. A belly glass 34 on which characters and the like of the slot machine 10 are depicted is provided on the front face of the lower portion of the main door 13, that is, below the control panel 20.

On a front surface of the top box 12, an upper image display panel 33 is provided. The upper image display panel 33 includes a liquid crystal display panel which displays, for example, images introducing the contents of games and explaining the rules of games.

A speaker 29 is provided in the top box 12. A ticket printer 35, a card reader 36, a data display 37 and a key pad 38 are provided beneath the upper image display panel 33. The ticket printer 35 prints on a ticket a bar code in which data such as the number of credits, date, time, identification number of the slot machine 10 and of the like data are encoded, and outputs the ticket 39 with a bar code. A player can make the ticket 39 with a bar code to be read by a second slot machine and play a game in the second slot machine, or exchange in a predetermined place (for example, at a cashier in the casino) of a recreation facility the ticket 39 with a bar code to notes and the like.

The card reader 36 is used for reading data from a smart card and writing data onto a smart card. The smart card is a card to be carried by a player, and for example, data to identify a player and data concerning a history of a game played by a player are stored thereon. Data corresponding to a coin, a note or a credit may also be stored on the smart card. As an alternative of a smart card, a magnetic stripe card may be adopted. The data display 37 is made of a fluorescent display and the like, and it is used, for example, to display data read by the card reader 36 and data input by a player through the key pad 38. The key pad 38 is used for inputting a command or data to issue a ticket and the like.

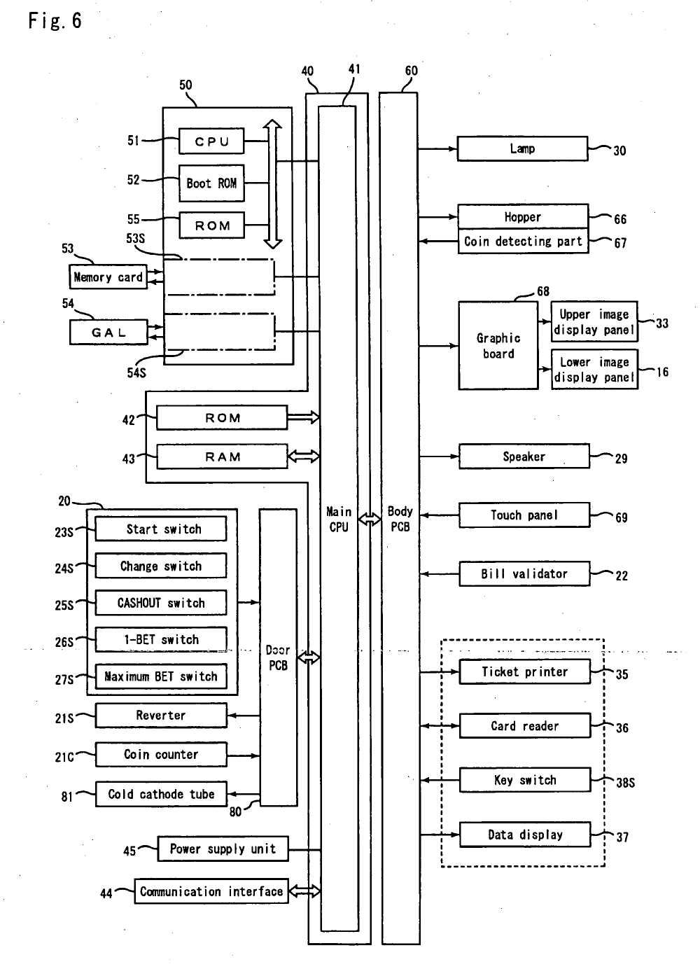

FIG. 6 is a block diagram showing the internal construction of the slot machine shown in FIG. 5.

A gaming board 50 includes: CPU (Central Processing Unit) 51, ROM 55 and boot ROM 52 which are interconnected to one another by an internal bus; a card slot 53S which accepts a memory card 53; an IC socket 54S which accepts GAL (Generic Array Logic) 54.

The memory card 53 is formed from a nonvolatile memory such as CompactFlash® and stores game programs and game system programs. The game programs include a symbol selection program. The aforementioned symbol selection program is a program for determining the symbols to be rearranged in a symbol matrix. The aforementioned symbol selection program includes symbol weighing data in association with plural types of payout ratios (for example, 80%, 84%, 88%). The symbol weighing data is data indicating the correspondence between respective symbols and one or more random numbers which fall in a predetermined numerical range (0 to 255). The payout ratios are determined based on payout-ratio setting data output from the GAL 54 and, based on the symbol weighing data associated with the payout ratios, the symbols to be rearranged in the symbol matrix are determined. Further, the game programs include table data (see FIG. 2) indicating the correspondence between symbols and payout values and data indicating correspondence between numbers BETs and sizes of a target (see FIG. 3).

Further, the card slot 53S is configured to allow the memory card 53 to be inserted thereinto or ejected therefrom and is connected to a mother board 40 through an IDE bus. Accordingly, the memory card 53 can be ejected from the card slot 53S, then other game programs and other game system programs can be written into the memory card 53 and then the memory card 53 can be inserted into the card slot 53S to change the types and contents of games played in the slot machine 10. The game programs include programs relating to progression of games. Further, the game programs include image data and sound data to be output during games. The image data includes image data indicating a symbol matrix, image data indicating targets, and the like.

The GAL 54 is a type of PLD having a fixed OR array structure. The GAL 54 includes plural input ports and plural output ports and, if predetermined data is input to an input port, the GAL 54 outputs data corresponding to the aforementioned data from an output port. The data output from this output port is the aforementioned payout-ratio setting data.

Further, the IC socket 54S is configured to allow the GAL 54 to be attached thereto and detached therefrom and is connected to the mother board 40 through a PCI bus. Accordingly, the GAL 54 can be replaced with another GAL 54 to change the payout-ratio setting data.

CPU 51, ROM 55 and boot ROM 52 interconnected to each other by the internal bus are connected to the mother board 40 by PCI bus.

The mother board 40 is constructed with a general-purpose mother board commercially available (a printed circuit board on which basic parts of a personal computer are mounted) and includes: a main CPU 41; ROM (Read Only Memory) 42; RAM (Random Access Memory) 43 and a communication interface 44. The mother board 40 is the controller of the present invention.

ROM 42 is constituted by a memory device such as a flash memory and stores thereon a program such as BIOS (Basic Input/Output System) executed by the main CPU 41 and permanent data. When BIOS is executed by the main CPU 41, not only is an initialization processing for predetermined peripheral devices conducted, but a capture processing for the game program and game system program stored on the memory card 53 is also started via the gaming board 50. In the present invention, contents of ROM 42 may be rewritable or not rewritable.

RAM 43 stores data and a program used at the time of operation of the main CPU 41. RAM 43 can also store the game program. RAM 43 further stores data on the number of credits, the number of coin-in or coin-out for one game, and the like.

Both a body PCB (Printed Circuit Board) 60 and a door PCB 80 which will be described later are connected to the mother board 40 by USB. A power supply unit 45 is also connected to the mother board 40.

Equipment and devices which generate input signals to be input to the main CPU 41, and equipment and devices of which operations are controlled by a control signal output from the main CPU 41 are connected to the body PCB 60 and the door PCB 80. The main CPU 41 executes a game program stored in RAM 43 based on an input signal input to the main CPU 41, and thereby performs a predetermined computational processing, stores results thereof into RAM 43 and transmits a control signal to each equipment and device as a control processing for each of the equipment and devices.

A lamp 30, a hopper 66, a coin detecting section 67, a graphic board 68, a speaker 29, a touch panel 69, a bill validator 22, a ticket printer 35, a card reader 36, a key switch 38S and a data display 37 are connected to the body PCB 60. The lamp 30 is lit up in a predetermined pattern based on a control signal output from the main CPU 41.

The hopper 66 is installed in the cabinet 11 and pays out a predetermined number of coins from a coin payout exit 19 to a coin tray 18 based on a control signal output from the main CPU 41. A coin detecting section 67 is installed inside the coin payout exit 19 and when detecting that a predetermined number of coins has been paid out from the coin payout exit 19, outputs an input signal to the main CPU 41.

The graphic board 68 controls, based on a control signal output from the main CPU 41, image displays to the upper image display panel 33 and the lower image display panel 16. The number of credits stored in RAM 43 is displayed to the number-of-credits display section 31 (not shown in the figure) of the lower image display panel 16. The number of coin-out is displayed to the number-of-payouts display section 31 (not shown in the figure) of the lower image display panel 16. The graphic board 68 is equipped with VDP (Video Display Processor) which generates image data based on a control signal output from the main CPU 41 and a video RAM which temporarily stores image data generated by VDP, and of the like equipments. Note that image data used in generating image data with VDP is contained in a game program read from the memory card 53 and stored in RAM 43.

The bill validator 22 not only discriminates a true note from a false note, but also accepts the true note into the cabinet 11. The bill validator 22, when accepting a true note, outputs an input signal to the main CPU 41 based on a face amount of the note. The main CPU 41 stores in RAM 43 the number of credits corresponding to the amount of the note transmitted with the input signal.

The ticket printer 35, based on a control signal output from the main CPU 41, prints on a ticket a bar code obtained by encoding data such as the number of credits, date and time, the identification number of the slot machine 10, and of the like data stored in RAM 43, and outputs the ticket as the ticket 39 with a bar code.

The card reader 36 transmits to the main CPU 41 data read from the smart card and writes data onto the smart card based on a control signal from the main CPU 41. The key switch 38S is provided on the keypad 38, and when the keypad 38 is operated by a player, outputs a predetermined input signal to the main CPU 41. The data display 37 displays, based on a control signal output from the main CPU 41, data read by the card reader 36 and data input by a player through the key pad 38.

The control panel 20, a reverter 21S, a coin counter 21C and a cold cathode tube 81 are connected to the door PCB 80. The control panel 20 is provided with a start switch 23S corresponding to the start button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. When the buttons 23 to 27 are operated by a player, each of the switches 23S to 27S corresponding thereto outputs input signals to the main CPU 41.

The coin counter 21C is installed inside the coin receiving slot 21, and discriminates whether a coin inserted by a player into the coin receiving slot 21 is true or false. Coins other than the true ones are discharged from the coin payout exit 19. The coin counter 21C also outputs an input signal to the main CPU 41 when a true coin is detected.

The reverter 21S operates based on a control signal output from the main CPU 41 and distributes coins recognized by the coin counter 21C as true coins into a cash box (not shown in the figure) or the hopper 66, which are disposed in the slot machine 10. In other words, when the hopper 66 is filled with coins, true coins are distributed by the reverter 21S into the cash box. On the other hand, when the hopper 66 is not filled with coins, true coins are distributed into the hopper 66. The cold cathode tube 81 works as a backlight installed on the back face sides of the lower image display panel 16 and the upper image display panel 33 and is lit up based on a control signal output from the main CPU 41.

Next, description will be given of a processing performed in the slot machine 10.

The main CPU 41 reads and executes the game program to progress a game.

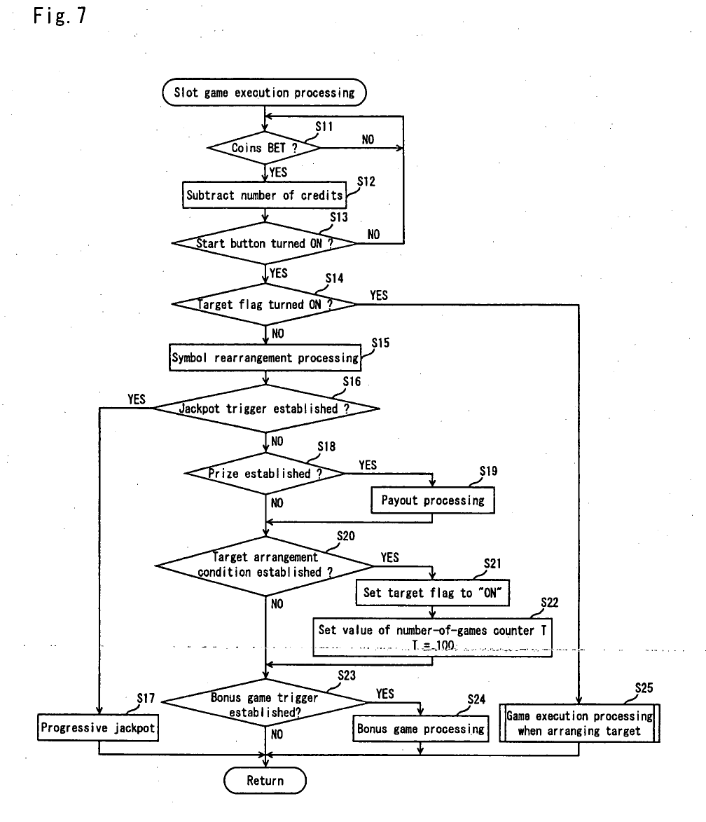

FIG. 7 is a flowchart showing a subroutine of a slot game execution processing.

In the slot game execution processing, the main CPU 41 at first determines whether or not a coin is BET (step S11). In the processing, the main CPU 41 determines whether an input signal output from the 1-BET switch 26S or the maximum BET switch 27S has been received or not when the 1-BET button 26 or the maximum BET button 27 is operated, respectively. If it is determined that a coin has not been BET, the process returns to step S11.

On the other hand, if it is determined in step S11 that a coin is BET, the main CPU 41 conducts a processing for subtracting the number of credits stored in RAM 43 according to the number of BET coins (step S12). In a case where the number of BET coins is more than the number of credits stored in RAM 43, the process returns to step S11 without conducting subtraction on the number of credits stored in RAM 43. In a case where the number of BET coins exceeds the upper limit (50 coins in the present embodiment) up to which a BET is possible in one game, the process advances to step S12 without conducting a processing for subtracting the number of BET coins from the number of credits stored in RAM 43. Further, the main CPU 41 cumulatively accumulates, in the RAM 43, a portion of the subtracted number of credits (for example, a predetermined ratio) as an accumulated value for a progressive jackpot.

Then, the main CPU 41 determines whether the start button 23 has been turned ON or not (step S13). In the processing, the main CPU 41 determines, when the start button 23 is pressed, whether an input signal output from the start switch 23S has been received or not.

If it is determined that the start button 23 has not been turned ON, the process returns to step S11. Note that in a case where the start button 23 has not been turned ON (for example, in a case where a command of terminating a game has been input without turning ON the start button 23), the main CPU 41 cancels a result of the subtracting processing in step S12.

On the other hand, if the main CPU 41 determines, at the step S13, that the start button 23 has been turned ON, the main CPU 41 determines whether or not a target flag has been set to “ON” (step S14). The target flag is a flag to which a reference is made in order to determine whether or not a target should be arranged. If the target flag has been set to “ON”, games in which a target T is arranged are executed. On the other hand, if the target flag has been set to “OFF”, games in which a target T is not arranged are executed. The target flag is set to “ON”, in the event that the target arrangement condition (that five or more target triggers are rearranged in the present embodiment) is established. The target flag is set to “OFF” in the event that the ending condition (that a predetermined number of games have been played since the start of arrangement of a target T) is established.

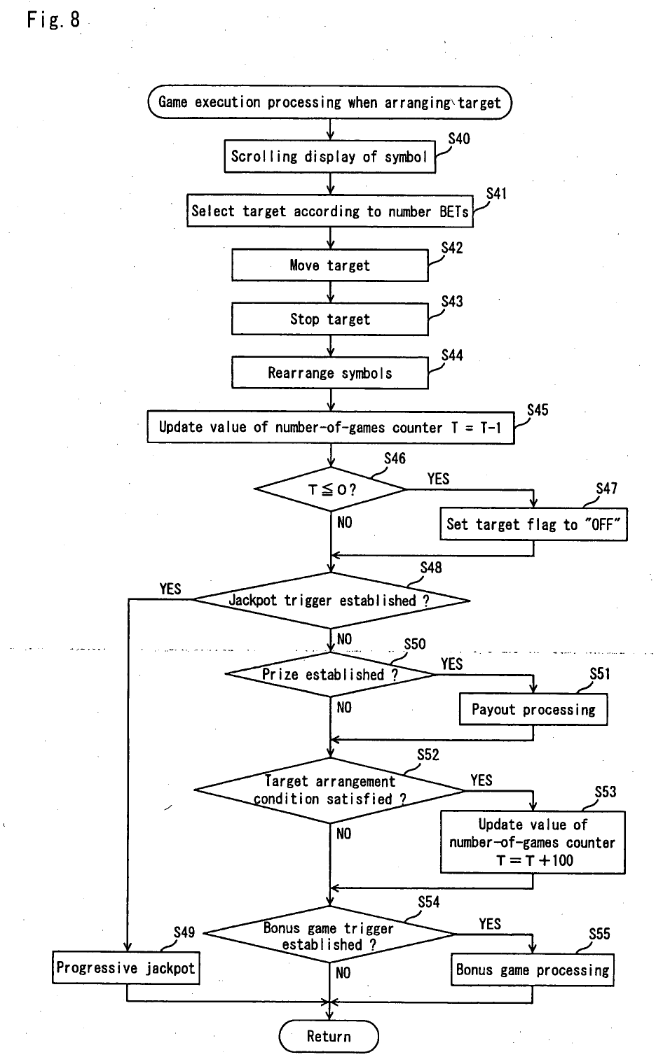

If the target flag has been set to “ON”, game execution processing in a case of arranging a target is conducted (step S25). This processing will be described later with reference to FIG. 8.

On the other hand, if the target flag has been set to “OFF”, the main CPU 41 conducts symbol rearrangement processing (step S15).

In this processing, the main CPU 41 executes the aforementioned symbol selection program to determine respective symbols to be rearranged within the symbol matrix SM and arranges the determined symbols within the symbol matrix SM.

Next, the main CPU 41 determines whether or not a jackpot trigger has been established, namely whether or not 5 or more of “SMILE” have been rearranged in the symbol matrix SM (step S16). If it is determined that a jackpot trigger has been established, a progressive jackpot is executed (step S17). The number of coins to be paid out based on a progressive jackpot corresponds to the accumulated value (a value resulted from accumulation of a portion of the number of inserted game media) stored in the RAM 43 plus an initial payout value, and the payout thereof is performed through hand-pay. At the step S17, the main CPU 41 conducts processing such as, for example, outputting of notification sound from a speaker 29, lighting of a lamp 30, printing of the ticket 39 with a bar code having a bar code indicating the number of coins to be paid out printed thereon. Thereafter, the present subroutine is terminated.

On the other hand, if the main CPU 41 determines, at the step S16, that no jackpot trigger has been established, the main CPU 41 determines whether or not a prize has been established (step S18). In this case, the establishment of a prize means rearrangement of 5 or more of at least one type of symbol out of “SUN”, “MOON”, “STAR”, “HEART” and “RIBBON” in the symbol matrix SM (see FIG. 2).

If the main CPU 41 determines that a prize has been established, the main CPU 41 pays out coins, according to the number of coins to be paid out defined for the symbols and the number of BETs (step S19). If the coins are to be accumulated, the main CPU 41 conducts processing for adding a predetermined number of credits to the number of credits stored in the RAM 43. On the other hand, if the coins are to be paid out, the main CPU 41 transmits a control signal to the hopper 66 to cause it to pay out a predetermined number of coins.

If it is determined, at the step S18, that no prize has been established or if the processing at the step S19 has been conducted, the main CPU 41 determines whether or not the target arrangement condition has been satisfied, namely whether or not five or more target triggers “JEWEL” have been rearranged in the symbol matrix SM (step S20). If the main CPU 41 determines that the target arrangement condition has been satisfied, the main CPU 41 sets the target flag to “ON” in the RAM 43 (step S21), and sets the value of a number-of-games counter T to T=100 (step S22).

If it is determined, at the step S20, that the target arrangement condition has not been satisfied or if the processing at the step S22 has been conducted, the main CPU 41 determines whether or not a bonus game trigger has been established, namely whether or not five or more of “CROWN” have been rearranged within the symbol matrix SM (step S23). If the main CPU 41 determines that a bonus game trigger has been established, the main CPU 41 reads, from the RAM 43, a program for executing a predetermined number of free games as bonus games and conducts bonus game processing (step S24). If it is determined, at the step S23, that no bonus game trigger has been established or if the processing at the step S24 has been conducted, the present subroutine ends.

If it is determined, at the step S14, that the target flag has been set to “ON”, the main CPU 41 conducts game execution processing in a case of arranging a target (step S25).

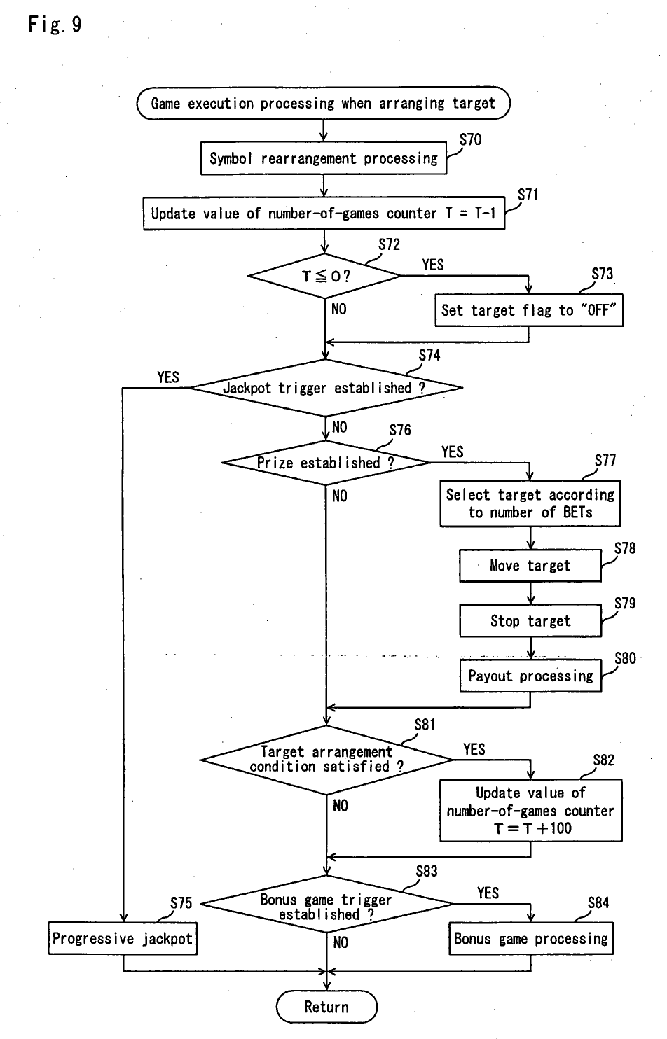

FIG. 9 is a flow chart illustrating a subroutine of the game execution processing in a case of arranging a target.

At first, the main CPU 41 performs scrolling display of symbols in the symbol matrix SM (step S40). Next, the main CPU 41 selects a target (see FIG. 3) according to the number of BETs (step S41). Next, as illustrated in FIG. 4A, the selected target T is arranged in the symbol matrix SM in such a manner that it is moved thereon (step S42). Thereafter, the target T is arranged on the symbol matrix SM such that it is stopped thereon (step S43). The position at which the target T is stopped can be determined as follows. That is, symbol positions can be associated with random numbers in advance and, at the step S43, a random number is selected and the symbol position associated with the selected random number can be determined as the position at which the symbol T is to be stopped.

Next, the main CPU 41 rearranges symbols (step S44). Thereafter, the main CPU 41 updates the value of the number-of-games counter T to T=T−1 (step S45). Next, the main CPU 41 determines whether or not the value of the number-of-games counter T is T≦0 (step S46) and, if the value of the number-of-games counter T is T≦0 or less, sets the target flag to “OFF” (step S47).

If it is determined, at the step S46, that the value of the number-of-games counter T is T≦0 or if it is determined that the target flag has been set to “OFF”, the main CPU 41 determines whether or not a jackpot trigger has been established (step S48). If a jackpot trigger has been established, the main CPU 41 performs payout based on a progressive jackpot (step S49).

On the other hand, if no jackpot trigger has been established, the main CPU 41 determines whether or not a prize has been established (step S50). If the main CPU 41 determines that a prize has been established, it conducts payout processing (step S51). In the payout processing, coins are paid out in such a way that the number of coin-out based on symbols S specified by the target T is twice the number of coin-out in the case where the symbols S are not specified by the target T. If it is determined, at the step S50, that no prize has been established or if the processing at the step S51 has been conducted, the main CPU 41 determines whether or not the target arrangement condition has been satisfied (step S52). If the main CPU 41 determines that the target arrangement condition has been satisfied, the main CPU 41 updates the value of the number-of-games counter T to T=T+100 (step S53). If it is determined, at the step S52, that the target arrangement condition has not been satisfied or if the processing at the step S53 has been conducted, the main CPU 41 determines whether or not a bonus game trigger has been established (step S54). If the main CPU 41 determines that a bonus game trigger has been established, it conducts bonus game processing (step S55). If it is determined, at the step S54, that no bonus game trigger has been established or if the processing at the step S49 or the step S55 has been conducted, the present subroutine ends.

As described above, the slot machine 10 according to the present embodiment includes the lower image display panel 16 to which the symbol matrix SM capable of arranging a total of 5×5=25 symbols and a target T (see FIGS. 1 and 3) which specifies any of the rearranged symbols are to be arranged. Further, the slot machine 10 includes the mother board 40 which functions as a controller. In the event that a predetermined target arrangement condition (that a predetermined number of or more target triggers are rearranged) is satisfied, the controller rearranges plural symbols within the symbol matrix SM, arranges a target T within the symbol matrix SM (see FIG. 4A) and conducts a payout according to the symbols rearranged within the symbol matrix SM in such a manner that the payout based on the rearranged symbols specified by the target T has a higher payout value than the payout in an event that the rearranged symbols are not specified by the target T.

Further, the slot machine 10 performs a slot machine playing method according to the present invention as follows.

The mother board 40 including the main CPU 41 functions as a controller. In the event that a predetermined target arrangement condition is satisfied, the controller rearranges plural symbols within the symbol matrix SM included in the lower image display panel 16, arranges a target T (see FIGS. 1 and 3) within the symbol matrix SM and offers a payout according to the symbols rearrange within the symbol matrix SM in such a manner that the payout based on the rearranged symbols specified by the target T has a higher payout value than the payout in an event that the rearranged symbols are not specified by the target T.

While, in the aforementioned example, there has been described a case where scrolling display of symbols and movement of a target are concurrently performed, the slot machine according to the present invention can be configured to arrange a target after rearranging symbols. For example, a subroutine illustrated in FIG. 9 can be conducted instead of the subroutine illustrated in FIG. 8 to employ the aforementioned configuration.

FIG. 9 is a flow chart illustrating another exemplary subroutine of game execution processing in a case of arranging a target.

At first, the main CPU 41 conducts symbol rearrangement processing (step S70) and updates the value of the number-of-games counter T to T=T−1 (step S71). Next, the main CPU 41 determines whether or not the value of the number-of-games counter T is T≦0 (step S72) and, if the value of the number-of-games counter T is T≦0, sets the target flag to “OFF” (step S73). If it is determined, at the step S72, that the value of the number-of-games counter T is not T≦0 or if the processing at the step S73 has been conducted, the main CPU 41 determines whether or not a jackpot trigger has been established (step S74). If the main CPU 41 determines that a jackpot trigger has been established, then it performs payout based on a progressive jackpot (step S75) and ends the present subroutine. On the other hand, if the main CPU 41 determines that no jackpot trigger has been established, it determines whether or not a prize has been established (step S76). If the main CPU 41 determines that a prize has been established, it selects a target (see FIG. 3) corresponding to the number of BETs (step S77), moves the target T within the symbol matrix SM (step S78), stops it (step S79) and conducts payout processing (step S80). At the step S80, the number of coin-out based on the rearranged symbols specified by the target T is set to twice the number of coin-out when the rearranged symbols are not specified by the target (see FIG. 2).

If it is determined, at the step S76, that no prize has been established or if the processing at the step S80 has been conducted, the main CPU 41 determines whether or not the target arrangement condition has been satisfied (step S81). If the main CPU 41 determines that the target arrangement condition has been satisfied, it updates the value of the number-of-games counter T to T=T+100 (step S82). If it is determined, at the step S81, that the target arrangement condition has not been satisfied or if the processing at the step S82 has been conducted, the main CPU 41 determines whether or not a bonus game trigger has been established (step S83). If the main CPU 41 determines that a bonus game trigger has been established, it conducts bonus game processing (step S84).

If it is determined that no bonus game trigger has been established or if the processing at the step S75 or the step S84 has been conducted, the present subroutine ends.

While, in the present embodiment, there has been described a case where symbols are displayed to a display, the present invention is not limited to the case and can employ, for example, mechanical reels as follows.

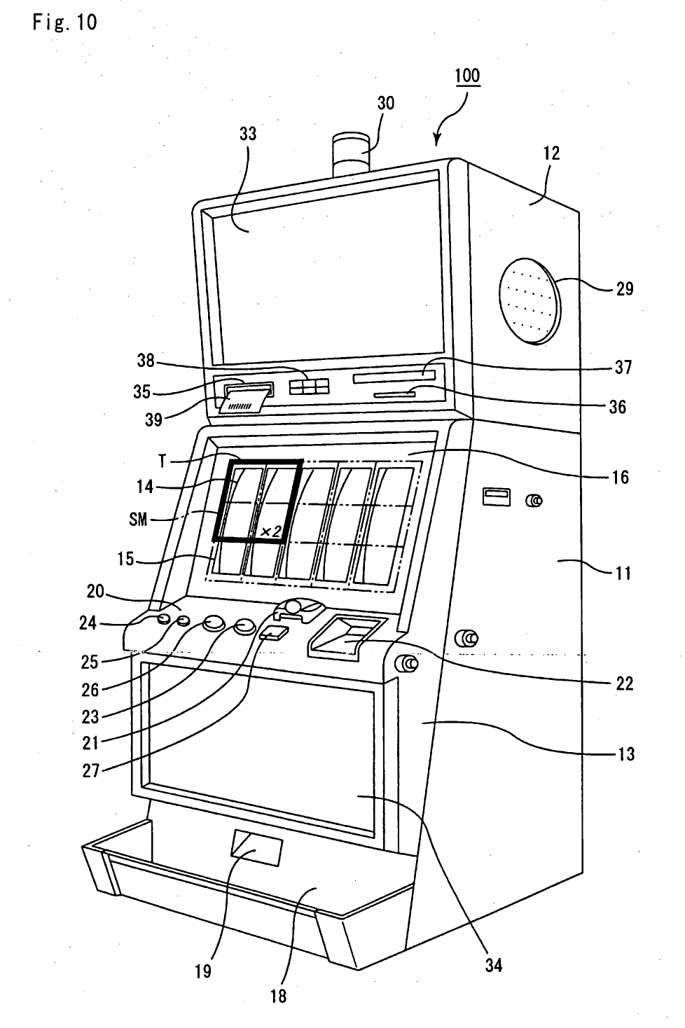

FIG. 10 is a perspective view schematically illustrating a slot machine according to another embodiment of the present invention.

The slot machine 100 includes a lower image display panel 16. The lower image display panel 16 includes a transparent liquid crystal display panel which can be switched between a transparent state and a non-transparent state. There are laterally arranged five reels 14 at the back of the lower image display panel 16. Further, at the positions corresponding to the respective reels 14, there are formed, in the lower image display panel 16, display windows 15 which display three symbols drawn on the peripheral surfaces of the reels 14. The five reels 14 and the display windows 15 which display three symbols on each reel 14 constitute a symbol matrix SM constituted by a total of 5×3=15 symbols. Further, on the lower image display panel 16, there is arranged a target T capable of specifying a total of 2×2=4 symbols.

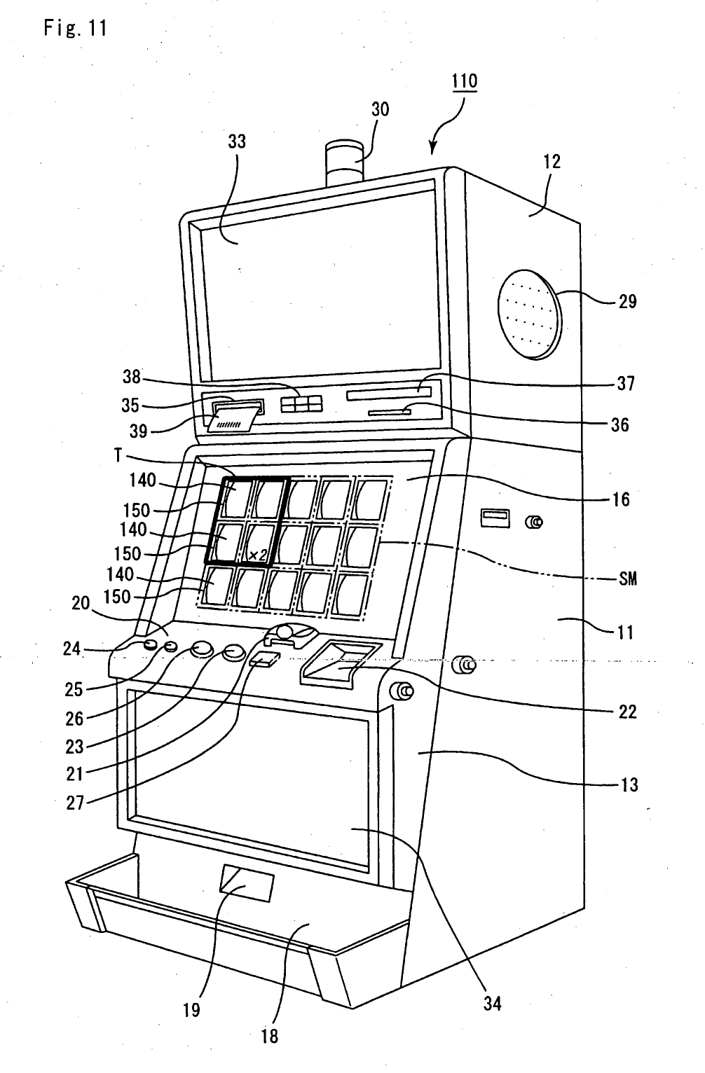

FIG. 11 is a perspective view schematically illustrating a slot machine according to still another embodiment of the present invention.

The slot machine 110 includes a lower image display panel 16. The lower image display panel 16 includes a transparent liquid crystal display panel which can be switched between a transparent state and a non-transparent state. There are arranged 5×3=15 reels 140 at the back of the lower image display panel 16. Further, at the positions corresponding to the respective reels 140, there are formed, in the lower image display panel 16, display windows 150 which display a single symbol drawn on the peripheral surfaces of the reels 140. The 15 reels 140 and the display windows 150 which display a single symbol on each reel 140 constitute a symbol matrix SM constituted by a total of 5×3=15 symbols. Further, on the lower image display panel 16, there is arranged a target T capable of specifying a total of 2×2=4 symbols.

Although the embodiment according to the present invention been described, the description presents only some of the specific examples, and is not intended to limit the present invention in any way and specific constructions of each means and the like can be properly changed in terms of design. Besides, the effects described in the embodiment of the present invention are only the most preferable effects generated from the present invention and effects to be caused by the present invention is not limited to those described in the embodiment of the present invention.

There has thus been outlined, rather broadly, the more important features of the invention in order that the detailed description thereof aforementioned may be better understood, and in order that the present contribution to the art may be better appreciated. There are, of course, additional features of the invention that described above and which formed the subject matter of the claims appended hereto.

In this respect, above explaining at least one embodiment of the invention in detail, it is to be understood that the invention is not limited in its application to the details of construction and to the arrangements of the components set forth in the aforementioned description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other systems and methods for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

The detailed descriptions aforementioned may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in many of the operations described herein which form part of the present invention; the operations are machine and/or manual operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

What is claimed as new and desired to be secured by Letters Patent of the United States is:

1. A slot machine comprising:
a display having a display area to which a plurality of symbols and a target specifying any of said symbols are to be arranged; and
a controller,
said controller rearranging the plurality of symbols within said display area and arranging said target within said display area, when a predetermined target arrangement condition is satisfied, and
conducting a payout based on a symbol rearranged within said display area, said payout set to such a value that a payout based on the rearranged symbol specified by said target has a higher payout value than a payout in an event that the rearranged symbol is not specified by said target.

2. The slot machine according to claim 1,
wherein
said controller further comprises
changing the size of said target in such a manner that the number of symbols which are to be specified by said target increases in accordance with increase in the number of BETs.

3. The slot machine according to claim 1,
wherein
said controller further comprises
increasing the payout based on the rearranged symbol specified by said target in accordance with the increase in the number of BETs.

4. A slot machine comprising:
a display having a display area to which a plurality of symbols and a target specifying any of said symbols are to be arranged; and
a controller,
said controller changing the size of said target in such a manner that the number of symbols which are to be specified by said target increases in accordance with increase in the number of BETs, when a predetermined target arrangement condition is satisfied,
rearranging the plurality of symbols within said display area and arranging said target within said display area, and
conducting a payout based on a symbol rearranged within said display area, said payout set to such a value that a payout based on the rearranged symbol specified by said target has a higher payout value than a payout in an event that the rearranged symbol is not specified by said target.

5. The slot machine according to claim 4,
wherein
said controller further comprises
increasing the payout based on the rearranged symbol specified by said target in accordance with the increase in the number of BETs.

6. A slot machine comprising:
a display having a display area to which a plurality of symbols and a target specifying any of said symbols are to be arranged; and
a controller,
said controller changing the size of said target in such a manner that the number of symbols which are to be specified by said target increases in accordance with increase in the number of BETs, when a predetermined target arrangement condition is satisfied,
rearranging the plurality of symbols within said display area and arranging said target within said display area, and
conducting a payout based on a symbol rearranged within said display area, said payout set to such a value that a payout based on the rearranged symbol specified by said target has a higher payout value than a payout in an event that the rearranged symbol is not specified by said target, and such that the payout based on the rearranged symbol specified by said target increases in accordance with the increase in the number of BETs.

7. A playing method of a slot machine comprising:
rearranging a plurality of symbols within a display area included in a display and arranging a target specifying any of said symbols within said display area, when a predetermined target arrangement condition is satisfied; and
conducting a payout based on a symbol rearranged within said display area, said payout set to such a value that a payout based on the rearranged symbol specified by said target has a higher payout value than a payout in an event that the rearranged symbol is not specified by said target, each of said steps conducted by a controller.

8. The playing method of a slot machine according to claim 7,
wherein
said controller further comprises
changing the size of said target in such a manner that the number of symbols which are to be specified by said target increases in accordance with increase in the number of BETs.

9. The playing method of a slot machine according to claim 7,
wherein
said controller further comprises
increasing the payout based on the rearranged symbol specified by said target in accordance with the increase in the number of BETs.

10. A playing method of a slot machine comprising:
changing the size of a target in such a manner that the number of symbols which are to be specified by said target increases in accordance with increase in the number of BETs, said target specifying any of the plurality of symbols arranged within a display area included in a display, when a predetermined target arrangement condition is satisfied;
rearranging the plurality of symbols within said display area and arranging said target within said display area; and
conducting a payout based on a symbol rearranged within said display area, said payout set to such a value that a payout based on the rearranged symbol specified by said target has a higher payout value than a payout in an event that the rearranged symbol is not specified by said target, each of said steps conducted by a controller.

11. The playing method of a slot machine according to claim 10,
wherein
said controller further comprises
increasing the payout based on the rearranged symbol specified by said target in accordance with the increase in the number of BETs.

12. A playing method of a slot machine comprising:
changing the size of a target in such a manner that the number of symbols which are to be specified by said target increases in accordance with increase in the number of BETs, said target specifying any of the plurality of symbols arranged within a display area included in a display, when a predetermined target arrangement condition is satisfied;
rearranging the plurality of symbols within said display area and arranging said target within said display area; and
conducting a payout based on a symbol rearranged within said display area, said payout set to such a value that a payout based on the rearranged symbol specified by said target has a higher payout value than a payout in an event that the rearranged symbol is not specified by said target, and such that the payout based on the rearranged symbol specified by said target increases in accordance with the increase in the number of BETs, each of said steps conducted by a controller.
